(19) United States
(12) Patent Application Publication
(10) Pub. No.: US 2025/0015700 A1
(43) Pub. Date: Jan. 9, 2025

(54) Direct Current Converter and Component Arrangement for an Electrical High-Voltage On-Board Power Supply of a Vehicle

(71) Applicant: Mercedes-Benz Group AG, Stuttgart (DE)

(72) Inventors: Markus ORNER, Rennigen (DE); Thomas WEBER, Herrenberg (DE); Nathan TROESTER, Stuttgart (DE); Urs BOEHME, Ehningen (DE); Akin CANDIR, Filderstadt (DE); Andreas KRUSPEL, Leinfelden-Echterdingen (DE); Matthias LEINFELDER, Tuebingen (DE); Keith Ren Qiang ONG, Boeblingen (DE)

(21) Appl. No.: 18/708,383

(22) PCT Filed: Nov. 7, 2022
(86) PCT No.: PCT/EP2022/081028

§ 371 Date: May 8, 2024

(30) Foreign Application Priority Data
Nov. 9, 2021 (DE) 10 2021 005 548.9

(51) Int. Cl. H02M 1/00; B60L 15/00; H02M 1/12; H02M 1/32; H02M 3/00; H02M 3/335

(52) U.S. Cl. CPC H02M 1/008; B60L 15/007; H02M 1/009; H02M 1/123; H02M 1/325; H02M 3/003; H02M 3/33523; B60L 2210/10

(57) ABSTRACT

A direct current converter includes a plurality of direct current converter modules having electrical input voltages and output voltages that differ from each other. The plurality of direct current converter modules are electrically connectable to one another to form a plurality of subsystems such that a high-voltage electrical voltage is convertible into different low-voltage electrical voltages. The plurality of direct current converter modules are configured as a shared integrated assembly. At least one of the plurality of subsystems is always active.

### BACKGROUND AND SUMMARY OF THE INVENTION

The invention relates to a direct current converter and to a component arrangement for an electrical high-voltage on-board power supply of a vehicle.

A vehicle having an electrical high-voltage on-board power supply is known, as is described in DE 2019 008 835 A1, from the prior art. The electrical high-voltage on-board power supply is sub-divided into two partial regions, wherein the first partial region is arranged in a first installation space of the vehicle, and the second partial region is arranged in at least one second installation space of the vehicle. The sub-division of the electrical high-voltage on-board power supply into the two partial regions is designed such that, in the first installation space of the vehicle, only work and electrical voltage of the first partial region of the electrical high-voltage on-board power supply is possible, and in at least one second installation space of the vehicle, work is possible in a no-voltage state of the second partial region of the electrical high-voltage on-board power supply.

An arrangement of at least one high-voltage battery having several storage cells that are electrically connected to one another and designed to store electrical energy on a self-supporting body of a passenger car is described in DE 10 2018 004 498 A1, from the prior art. The high-voltage battery, and further high-voltage components provided in addition to the high-voltage battery and electrically connected to the high-voltage battery, are at least indirectly held on the body. The body forms a high-voltage safety cell that can be tempered by means of a tempering device of the passenger car, the high-voltage battery and the further high-voltage components being arranged in the high-voltage safety cell.

An electric on-board power supply for a motor vehicle is known from DE 10 2018 002 926 A1. It comprises at least one first and one second electrical potential connection, and is designed, in an operation as intended, to have a direct current applied to it between the potential connections. The on-board power supply has at least one Y condenser, which is electrically coupled with a first connector to the potential connections, and with a second connector to an electrical reference potential. A switch element is connected in series to at least one Y condenser.

In DE 10 2019 008 825 A1, a vehicle having an electrical high-voltage on-board power supply is described. The electrical high-voltage on-board power supply is sub-divided into three partial regions, wherein the first partial region is arranged in a first installation space of the vehicle, the second partial region is arranged in a second installation space of the vehicle, and the third partial region is arranged outside of these two installation spaces of the vehicle.

In DE 10 2021 003 831, an electrical on-board power supply for a vehicle, a vehicle having an electrical on-board power supply and a method for operating an electrical on-board power supply for a vehicle are described. The electrical on-board power supply comprises a battery having two electrical battery potential contacts, and a direct current charging connector having two electrical charging potential contacts in the vehicle. A direct current converter is provided. The first electrical battery potential contact is or can be electrically coupled with a first electrical potential contact of an output side of the direct current converter. The second electrical battery potential contact is or can be electrically coupled with the second electrical charging potential contact. The respective electrical charging potential contact is or can be electrically coupled with a respective electrical potential contact of an input side of the direct current converter. A second electrical potential contact of the output side of the direct current converter is or can be electrically coupled with the electrical potential contact of the input side of the direct current converter. The electrical potential contacts of the input side of the direct current converter are respectively electrically coupled with one electrical connector contact of a first condenser. The electrical potential contacts of the output side of the direct current converter are or can be respectively electrically coupled with one electrical connector contact of a second condenser.

The object of the invention is to specify an improved direct current converter in relation to the prior art, and an improved component arrangement in relation to the prior art for an electrical on-board power supply of a vehicle.

According to the invention, a direct current converter, in particular for a vehicle, has several direct current converter modules having electrical input voltages and output voltages that differ from each other, which are designed as a shared integrated component, in particular in a shared converter housing, and can be electrically connected to one another in several subsystems such that an electrical high voltage can be converted into different electrical low-voltage voltages. The direct current converter is also described as a DC/DC converter, and due to the conversion of the electrical high-voltage voltage into several electrical low-voltage voltages, also as an LV DC/DC converter.

In particular, a direct current converter module for converting the high-voltage voltage into a low-voltage voltage is provided, and the other direct current converter modules are provided to convert a low-voltage voltage into another low-voltage voltage. For example, the other direct current converter modules can then respectively be coupled with an output side of the direct current converter module converting the high-voltage voltage, in order to convert its low-voltage voltage into another low-voltage voltage, or be coupled with an output side of another of the direct current converter modules to transform its low-voltage voltage into another low-voltage voltage.

The direct current converter according to the invention is thus designed to be modular, such that it can fulfil several functions, in particular supply or couple several electrical low-voltage on-board power supplies. Different voltage levels, for example 12 V and 48 V, can thus simultaneously be switched, and, for this purpose, different subsystems are switched on or switched off internally for this purpose.

The direct current converter according to the invention can for example be used in a component arrangement for an electrical high-voltage on-board power supply of a vehicle. A component arrangement according to the invention thus comprises this direct current converter. This component arrangement is also described as a conversion box. In the component arrangement, for several electrical components, a shared EMC filter (EMC=electromagnetic compatibility) and a shared intermediate circuit are provided, wherein these electrical components are arranged in a shared housing together with the shared EMC filter and the shared intermediate circuit. The electrical components, for which the shared EMC filter and the shared intermediate circuit are provided, are in particular power electronics for at least one electric drive engine for driving the vehicle, a rectifier and/or the direct current converter. In this component arrangement, all of the substantial components of a high-voltage system are advantageously arranged in a bow, i.e., in a shared housing, and should be connected to one another, such that this box can advantageously be used universally, in particular with the same structure. The component parts of this component arrangement are advantageously also universal. This applies in the example described here in particular to the direct current converter, which can fulfil several functions, and serve several low-voltage on-board power supplies.

The direct current converter can advantageously fulfil all the requirements simultaneously. The individual functions can for example be activated or deactivated by means of software and/or switching. The direct current converter, and advantageously the component arrangement, can thus be used, in particular with the same structure, for all possible requirements, and then be adjusted in a use case in software or in an application such that the desired functions are fulfilled.

All low-voltage connectors required for this purpose are advantageously provided on the housing of the component arrangement, and are or can be electrically coupled with the direct current converter. For the respective usage of the component arrangement, low-voltage connectors not being used are the closed, for example covered.

In particular to adjust to the different possible functions described above, and the different low-voltage voltages required for the latter, and also to different required powers, the subsystems of the direct current converter can advantageously be activated and deactivated independently of one another. It can also be provided that at least one of the subsystems is always active. A simplified structure can thus be generated because not all subsystems of the direct current converter have to be able to be switched off.

As described above, the direct current converter modules are designed as a shared integrated component, in particular in a shared converter housing. Thus, it is not only a parallel circuit of several direct current converters.

As an alternative to the use of the direct current converter described above in the component arrangement also described as a conversion box, it can for example also be provided that the direct current converter is connected as an independent component outside of such a component arrangement or, without this component arrangement, directly to a high-voltage system. Without a shared use of the EMC filter and intermediate circuit of the independent components, the EMC compatibility and an intermediate circuit must still be ensured by the high-voltage system, such that the independent components mostly have an own EMC filter and intermediate circuit assigned to the component. This EMC filter and intermediate circuit can then in particular be housed in the housing of the component.

The direct current converter according to the invention, via its modular design, makes a structure of several low-voltage voltage on-board power supplies possible in a cost-efficient manner. This is in particular required in electric vehicles for operating safety-critical functions and for simultaneously operating different consumers or supplies in own low-voltage on-board power supplies.

The direct current converter modules advantageously have a low power. They are used, as described above, for different low-voltage voltage on-board power supplies. If greater low-voltage powers are required, several of the direct current converter modules or subsystems are switched in parallel on their output end. An efficient operation in the operation under partial load is thus made possible.

The direct current converter according to the invention makes it possible, as already mentioned, to reduce costs by using a module system for different functions when converting low-voltage voltage, to increase energy efficiency by switching off one or more subsystems in a targeted manner at a low low-voltage load in a respective low-voltage on-board power supply, because direct current converters have their highest efficacy in the nominal operating point, and to easily be able to generate several low-voltage on-board power supplies in the vehicle. A new development of a direct current converter for changed function requirements further develops, for example for increased on-board power-supply requirements, or if an additional converter is required for a solar roof.

The direct current converter according to the invention can additionally be used for safe low-voltage voltage generation in safety-critical applications, for example for highly automated driving and steer-by-wire.

Exemplary embodiments of the invention are explained in more detail in the following with reference to drawings.

### BRIEF DESCRIPTION OF THE DRAWINGS

FIG. 1 schematically shows a direct current converter; and

FIG. 2 schematically shows a component arrangement for an electrical high-voltage on-board power supply of a vehicle.

### DETAILED DESCRIPTION OF THE DRAWINGS

Parts corresponding to one another are provided with the same reference numerals in all figures.

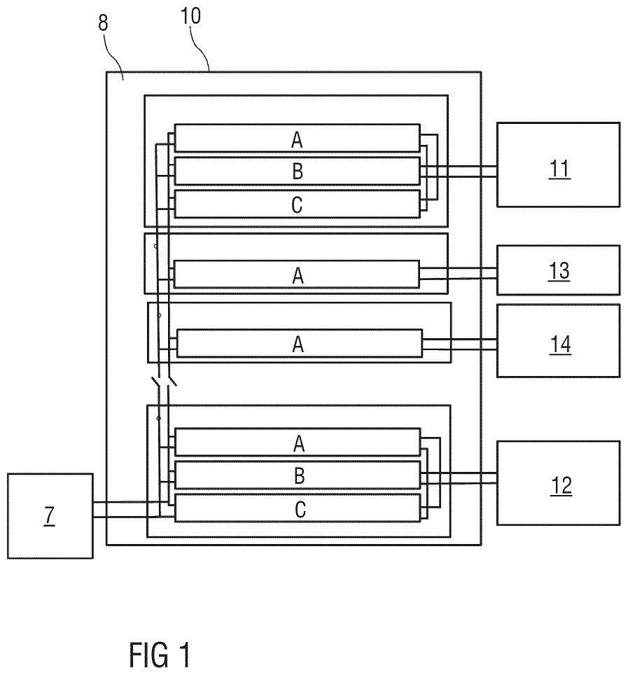

FIG. 1 shows a schematic depiction of an embodiment of a direct current converter 8, in particular for a vehicle. It has several direct current converter modules having electrical input voltages and output voltages that differ from each other, which are designed as a shared integrated component, in particular in a shared converter housing 10, and can be electrically connected to one another in several subsystems A B C such that an electrical high voltage can be converted into different electrical low-voltage voltages.

The direct current converter module can thus in particular be electrically switched such that in electric vehicles, which have a high-voltage battery 7, several low-voltage voltage on-board power supplies can be generated, in particular with different low-voltage voltages.

In the depicted example, the direct current converter 8 is used in this manner for a low-voltage on-board power supply 11 having a first low-voltage voltage level, for example for consumers, and a low-voltage battery, for a low-voltage on-board power supply 12 having a second low-voltage voltage level deviating from the latter, for example for further consumers, and a further low-voltage battery for an energy recovery 13, for example for a solar module and/or a steamer system, and for a self-supply 14, in particular for low-voltage components in a high-voltage electrical/electronic installation space.

The direct current converter 8 is also described as a DC/DC converter, and due to the conversion of the electrical high-voltage voltage into several electrical low-voltage voltages, also as an LV DC/DC converter.

The subsystems A, B, C are for example also respectively described as a rail, in particular due to the electrical switching of the direct current converter module by means of conductor rails. However, an electrical switching by means of cables is also possible.

The solution described is thus a modular direct current converter 8 for converting a high-voltage voltage into different low-voltage voltages, which can in particular be used in vehicles designed as electric vehicles.

In particular, a direct current converter module for converting the high-voltage voltage into a low-voltage voltage is provided, and the other direct current converter modules are provided to convert a low-voltage voltage into another low-voltage voltage. For example, the other direct current converter modules can then respectively be coupled with an output side of the direct current converter module converting the high-voltage voltage, in order to convert its low-voltage voltage into another low-voltage voltage, or be coupled with an output side of another of the direct current converter modules to transform its low-voltage voltage into another low-voltage voltage.

With the first direct current converter module, the high-voltage voltage, for example 800 V, in particular galvanically separated, is thus converted to a low-voltage voltage, for example of 48 V. If, for example, a lower low-voltage voltage is required, this lower low-voltage voltage, for example 12V by a further, in particular galvanically coupled direct current converter module. For this purpose, these two direct current converter modules are electrically switched with each other to form a subsystem A, B, C. The first direct current converter module for converting the high-voltage voltage can for example already form an own subsystem ABC. In the exemplary case, the direct current converter 8 thus has a subsystem A, B, C with the high-voltage voltage as an input voltage and the high low-voltage voltage as an output voltage, and a further subsystem B, C, A with the high-voltage voltage as an input voltage and the low-voltage voltage as an output voltage. In the example depicted in FIG. 1, three subsystems A, B, C are provided, which can respectively be designed in the manner described or with more direct current converter modules that are coupled with each other.

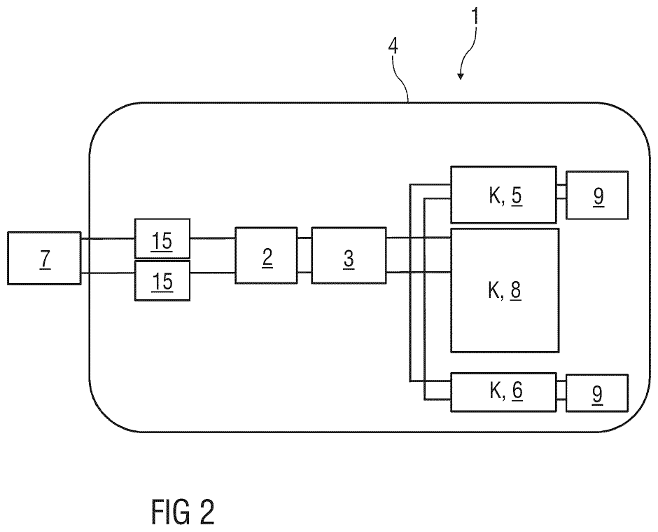

Advantageously, each subsystem A, B, C is completed on its output side with an EMC filter 9, in the following, in particular with reference to FIG. 2, described as a further EMC filter 9.

The direct current converter module can advantageously be operated bi-directionally. A pre-charging of a high-voltage on-board power-supply of the vehicle is thus enabled.

The individual direct current converter modules are in particular designed for a low nominal power, for example 500 W.

In a possible embodiment, the first direct current converter module, i.e., the direct current converter module, is designed to convert the high-voltage voltage into the high low-voltage voltage, for example of 48 V, in a safe and functionally reliable operation. It then additionally contains an integrated, short-circuit proof switch-off on the high-voltage side, and additionally fulfils functional requirements to fulfil high ASIL levels, for example for ASIL D. This direct current converter module can thus be directly connected to the high-voltage battery 7, in particular without circuit breaking, and be used for safety-critical functions, for example steer-by-wire, and highly-automated driving functions, without additional low-voltage batteries.

As shown in FIG. 1, the individual subsystems A, B, C are electrically switched in parallel on the high-voltage side, i.e., on the input side. On the low-voltage side, as already specified above, several low-voltage on-board power supplies can be generated.

If a required low-voltage on-board power exceeds the power provided by a respective subsystem A, B, C, several subsystems A, B, C are advantageously also electrically switched in parallel on the output side, i.e., on the low-voltage side. When the load changes during operation, individual subsystems A, B, C can be turned on or turned off again depending on the use case. It is thus achieved that the individual subsystems A, B, C, which are respectively in operation, also work high effectively when there is a low voltage load.

The direct current converter 8 makes it possible to reduce costs by using a module system for different functions when converting low-voltage voltage, to increase energy efficiency by switching off one or more subsystems A, B, C in a targeted manner at a low low-voltage load in a respective low-voltage on-board power supply, because direct current converters 8 have their highest efficacy in the nominal operating point, and to easily be able to generate several low-voltage on-board power supplies in the vehicle. A new development of a direct current converter when function requirements are changed further develops, for example for increased on-board power-supply requirements, or if an additional converter is required for a solar roof.

The direct current converter 8 can additionally be used, as described above, for safe low-voltage voltage generation in safety-critical applications, for example for highly automated driving and steer-by-wire.

The direct current converter 8 can for example be used in a component arrangement for an electrical high-voltage on-board power supply of a vehicle, as shown in an exemplary form in FIG. 2.

In this component arrangement 1, for several electrical components K, a shared EMC filter 2 and a shared intermediate circuit 3 are provided, wherein these electrical components K are arranged in a shared housing 4 together with the shared EMC filter 2 and the shared intermediate circuit 3.

The shared intermediate circuit 3 is for example designed as a condenser.

The unit, having the housing 4 and having the electrical components K, the shared EMC filter 2 and the shared intermediate circuit 3, which are located in the housing 4, is also described as a conversion box.

This solution makes a simplified and unified structure of a high-voltage system of a vehicle possible, because different electrical components K can share the intermediate circuit 3 and the shared EMC filter 2 in common, wherein these parts, i.e., the intermediate circuit 3 and the shared EMC filter 2, are then designed to be able to fulfil the function of all of these components K. In this way, these components K do not themselves need to have their own EMC filters and intermediate circuits, and can for example be constructed more compactly. In this solution, all substantial component parts of the high-voltage system for a vehicle are thus advantageously arranged in a housing 4, i.e., in a box, and connected to one another, such that this box can be used universally, in particular with the same structure, for different vehicles, and in particular for different vehicle types.

The electrical components K, for which the shared EMC filter 2 and the shared intermediate circuit 3 are provided, are for example, as shown in FIG. 2, power electronics 5 for at least one drive engine for driving the vehicle, a rectifier 6, also described as an AC/DC converter, in particular for alternating current charging the high-voltage battery 7 of the vehicle, and the direct current converter 8.

The power electronics 5 preferably has a galvanic coupling for the at least one electric drive engine, and the rectifier 6 and the direct current converter 8 respectively have a galvanic separation.

Optionally, it can be provided that a further EMC filter 9 is arranged at an exit of the respective component K, i.e., one or more or all of the components K can respectively have an own further EMC filter 9 at their exit. This respective further EMC filter 9 can for example be arranged in the shared housing 4. In the depicted example, such further EMC filters are represented for the power electronics 5 and the rectifier 6. Because the direct current converter 8 has several exits, a further EMC filter 9 can respectively be provided at the respective exit, i.e., at one or more of the exits or at all exits.

In a possible further embodiment, it can be provided that no further component K for the rectifier 6 also described as an AC/DC converter for alternating current charging the high-voltage battery 7 is present, but rather this function is also taken on by an inverter of the power electronics 5 for the at least one electric drive engine. The function of alternating current charging and the function of engine alternating inverter, also described as an inverter, are in particular implemented by a semiconductor circuit. In this embodiment, a safety unit is advantageously provided at the exit of the power electronics 5 for the at least one electric drive engine in the direction of the alternating current charging connector to implement the alternating current function, the safety unit for example being arranged between the power electronics 5 for the at least one electric drive engine and the further EMC filter 9. This safety unit serves to maintain safety and EMC norms. The galvanic coupling requires additional measures, e.g., an emergency switch-off and a neutralization of PE discharge currents.

In a further embodiment, it can for example be provided that no alternating current charging function is integrated. The components K, which share the shared intermediate circuit 3 and the shared EMC filter 2, would then be only the power electronics 5 for the at least one electric drive engine, and the direct current converter 8.

As described, the components K specified above share the same intermediate circuit 3 and the shared EMC filter 2 on the direct current side. They additionally have separable exits, in the depicted example to the high-voltage battery 7. Separating elements 15 for this purpose are for example respectively designed as a semiconductor fuse or protection/CSID. A semiconductor fuse can for example respectively be provided on both poles, or a protection/fuse combination can be provided on both poles, or a protection/CSID can respectively be provided on both poles, or a fuse can be provided on one pole and a semiconductor fuse can be provided on the other pole.

The components K are in particular respectively designed as a semi-conductor component.

In addition, a microcontroller 16 can be provided, which is also arranged in the housing 4. This microcontroller is also in particular designed as a semiconductor component.

The shared intermediate circuit 3 and the shared EMC filter 2 are in particular respective designed as a passive component part.

The separating elements 15 are in particular designed as a passive semiconductor component, for example as a semiconductor fuse. As an alternative, the separating elements 15 can for example be designed as a protection or CSID, which is then conversely a mechanical component.

The respective further EMC filter 9, if it is provided, is in particular designed as a passive component.

The components of the component arrangement 1, in particular of the conversion box, described above, in particular arranged in the housing 4, in particular the components K, are advantageously implemented together in the form of highly integrated power electronics, i.e., the component arrangement 1, in particular in the housing 4, does not have any individual component parts, but only the highly integrated performance electronics.

The described solution in particular makes it possible to compactly integrate high-voltage functionalities, for example electrical switching, charging, conversion, inversion, which then for example also makes a more compact structure and/or reduction in costs possible.

The described solution advantageously uses a shared installation space for all of the high-voltage functionalities, in particular switching, charging, conversion and inversion. Via the shared usage of passive component parts, such as the shared EMC filter 2, and the intermediate circuit capacity, i.e., the shared intermediate circuit 3, synergies are used. A compact structure is thus enabled. By replacing mechanical fuse/switch-off elements, in particular protections, with semiconductor switches for separating the high-voltage battery 7, mechanical component parts are not required for the function of switching. Advantageously, power electronic semiconductors are used to implement all of the core functions, in particular core functions, in particular switching, conversion, charging, inversion.

By this implementation of all of the substantial functions via semiconductors, a high semiconductor integration can be achieved. An implementation of function variants and/or additional functions, for example due to special equipment, for example special equipment for alternating current charging, is advantageously implemented in the software, and not, as previously, by changing the hardware, because individual functions cannot be removed from the overall high-voltage power electronics. In addition, functions can thus also be bought and released depending on vehicle production.

To be able to use the shared EMC filter 2 for all functionalities, the controls of the individual semi-conductor groups are advantageously coordinated with one another.

As already mentioned, the described solution advantageously uses a shared installation space for all of the high-voltage functionalities, in particular switching, charging, conversion and inversion. In the embodiment in which the function of the rectifier 6 of alternating current charging the high-voltage battery 7 is taken over by the inverter of the power electronics 5 for the at least one electric drive engine, such that no separate rectifier 6 is provided, synergies are not only used in passive components, but rather, in addition, a semiconductor circuit is used for the motor control and for the alternating current charging function. That is, in addition to the synergies in passive component parts, the synergy is thus also used on the level of the semiconductor circuit for the motor control and for the alternating current charging functionality. By this additional use of synergies in active components too for the converter of the drive and of the alternating current charging, a more compact structure and an additional reduction in costs are possible. The combination of the different functions, in particular the alternating current charging function and the driving function, by means of the at least one electric drive engine, to form the superordinate function of energy conversion, is a consequent further development of the trend in the battery-electric vehicle sector of high integration, and takes into account the trend of semiconductor development.

### LIST OF REFERENCE CHARACTERS

1 component arrangement
2 shared EMC filter
3 intermediate circuit
4 housing
5 power electronics
6 rectifier
7 high-voltage battery
8 direct current converter
9 further EMC filter
10 converter housing
11 low-voltage on-board power supply having a first low-voltage voltage level
12 low-voltage on-board power supply having a second low-voltage voltage level
13 energy recovery
14 self-supply
15 separating element
A. B. C subsystem
K component

1-7. (canceled)

8. A direct current converter (8), comprising:
a plurality of direct current converter modules having electrical input voltages and output voltages that differ from each other, wherein the plurality of direct current converter modules are electrically connectable to one another to form a plurality of subsystems (A, B, C) such that a high-voltage electrical voltage is convertible into different low-voltage electrical voltages;
wherein the plurality of direct current converter modules are configured as a shared integrated assembly;
wherein at least one of the plurality of subsystems (A, B, C) is always active.

9. The direct current converter (8) according to claim 8, wherein a first one of the plurality of direct current converter modules converts the high-voltage electrical voltage into a first low-voltage voltage and a second one of the plurality of direct current converter modules converts the first low-voltage voltage into a second low-voltage voltage.

10. The direct current converter (8) according to claim 8, wherein the plurality of subsystems (A, B, C) are activatable and deactivatable independently of each other.

11. A component arrangement (1) for an electrical high-voltage on-board power-supply of a vehicle, comprising:
the direct current converter (8) according to claim 8.

12. The component arrangement (1) according to claim 11, further comprising:
a shared electromagnetic compatibility (EMC) filter (2);
a shared intermediate circuit (3);
a plurality of electrical components (K); and
a shared housing (4);
wherein the shared EMC filter (2) and the shared intermediate circuit (3) are provided for the plurality of electrical components (K);
wherein the plurality of electrical components (K), the shared EMC filter (2), and the shared intermediate circuit (3) are disposed in the shared housing (4).

13. The component arrangement (1) according to claim 12, wherein the plurality of electrical components (K) comprise power electronics (5) for at least one electric drive engine for driving the vehicle, a rectifier (6), and/or the direct current converter (8).
